(19) United States
(12) Patent Application Publication
(10) Pub. No.: US 2025/0178105 A1
(43) Pub. Date: Jun. 5, 2025

(54) Shear Jaw Blades with Protective Liner System

(71) Applicant: Michael Richard Ramun, Mineral Ridge, OH (US)

(72) Inventor: Michael Richard Ramun, Mineral Ridge, OH (US)

(21) Appl. No.: 18/524,817

(22) Filed: Nov. 30, 2023

(51) Int. Cl. B23D 35/00

(52) U.S. Cl. CPC B23D 35/002; B23D 35/001

(57) ABSTRACT

A jaw of a jaw set used for construction or demolition applications has liners positioned between the blade pockets of the jaw set body and the blades of the jaw set to protect the blade pockets of the jaw set body from contact with worn or deformed blades during operation so that the worn or deformed blades do not damage the blade pockets of the jaw bodies. Such damage is inherent with the common utilization of worn or deformed blades.

### BACKGROUND OF THE INVENTION

### Field of the Invention

The present invention relates to a jaw set for demolition, recycling, and/or material processing equipment. More particularly, the present invention relates to blade liners that are used between the blade pocket and the blade to protect the blade pocket of the jaw body.

### Description of Related Art

The present application refers to a jaw set for use with demolition equipment. However, the equipment is also referred to as construction equipment, scrap handling equipment, and the like. The description of demolition equipment or construction equipment is not intended to be restrictive of the equipment being referenced. Demolition equipment, such as heavy-duty metal cutting shears, have been mounted on excavators and other construction equipment powered by hydraulic cylinders for a variety of jobs in the demolition field. This equipment provides for the efficient cutting and handling of scrap. For example, in the dismantling of an industrial building, metal scrap in the form of various diameter pipes, structural I-beams, channels, angles, sheet metal plates and the like, must be efficiently severed and handled by heavy-duty metal shears.

FIG. 1 is prior art and is a perspective view of a jaw set having a first jaw 13 pivotally connected to a second jaw 15 about a pivot pin 16. A second jaw body 15a of the second jaw 15 is illustrated with the blades of the second blade set 14 spaced from the pocket wall of the second jaw body 15a with shims 17. The purpose of the shims 17 is to adjust the position of the blades within the second blade set 14 relative to the second jaw body 15a for precise location of the blades relative to the second jaw body 15a. The shims are intended for the purpose of properly locating the second blade set 14 relative to the second jaw body 15a.

Over time, blades when used become worn and/or deformed. Securing a worn or deformed blade in the blade pocket may be detrimental to the pocket. As a result, the blade may move during operation causing unnecessary wear to the pocket. Additionally, if the blade is deformed and not properly seated within the pocket, then the forces against the blade during operation will not be uniformly distributed and the pocket will become deformed. In particular, a worn or deformed blade does not properly seat in the pocket and the bolts securing the blade may shear causing the blade to fall from the pocket during operation. It is desirable to provide an arrangement whereby the blade pockets of the second jaw body 15a, and furthermore the blade pockets of the first jaw body 13a, are protected from wear or damage that may be imparted by using worn or deformed blades. Over time, the blade pocket may be worn or deformed to the extent that a blade may no longer be properly secured therein. Such damage is inherent with the common utilization of worn or deformed blades.

### SUMMARY OF THE INVENTION

A jaw is configured to be part of a jaw set for demolition, recycling, or material processing equipment. The jaw has a jaw body with a bore extending through the jaw body configured to be mated with a pin extending through a jaw body bore wherein the first jaw is adapted to allow relative rotation between the first jaw and a second jaw, and wherein the jaw body bore has a central axis extending therethrough and a cutting region defined between the jaw body bore and an end of the jaw body. The jaw body also has a first pocket extending away from the jaw body bore toward the end of the jaw body. The first pocket has a first pocket side wall oriented in a direction perpendicular to the central axis of the jaw body bore. The first pocket also has a first pocket end wall perpendicular to the first pocket side wall. A first blade is mounted in the first pocket. The first blade has a first blade side wall oriented in a direction perpendicular to the central axis of the jaw body bore and a first blade end wall perpendicular to the first blade side wall. A first end wall liner extends within the first pocket and overlaps with the first blade. The first end wall liner is positioned between the first pocket end wall and the first blade end wall to protect the first pocket end and the jaw body.

### BRIEF DESCRIPTION OF THE DRAWING(S)

FIG. 1 is prior art and is a perspective view of a jaw set with shims between the jaw body and the blades.

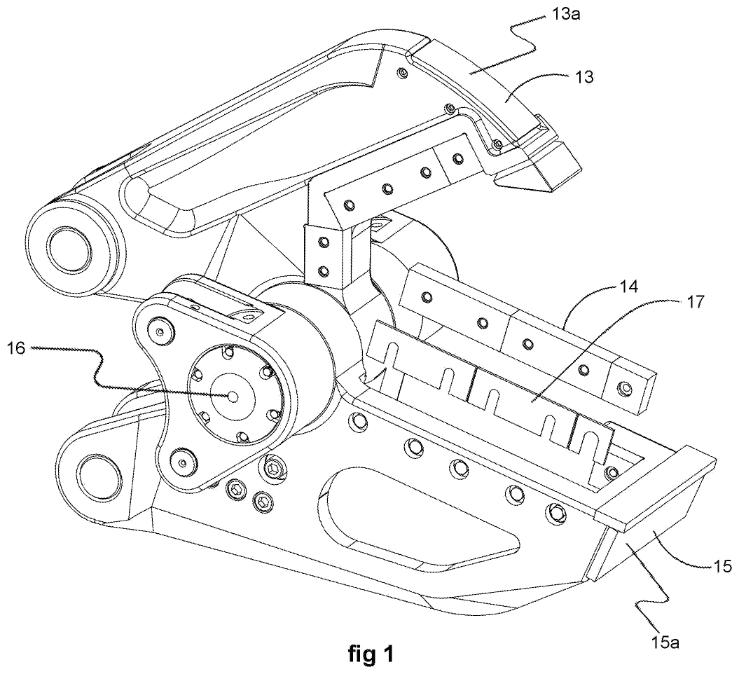

FIG. 2A is a side view of a shear demolition tool with two movable jaws;

FIG. 2B is a side view of a shear demolition tool with one movable jaw;

FIG. 3 is a perspective view of a jaw set utilizing liners in accordance with the subject invention;

FIG. 4 is a different perspective of the jaw set in FIG. 3;

FIG. 5 is an exploded perspective view of the jaw set illustrated in FIG. 3;

FIG. 6 is a perspective view of a first jaw of the jaw set illustrated in FIG. 3 with the liners shown in an exploded view;

FIG. 7 is a perspective view of a first jaw of a jaw set in FIG. 6 with the liners positioned within the pocket;

FIG. 8 is a perspective view of the first jaw in FIG. 6 with the liners in place and the blades shown in an exploded position;

FIG. 9 is a perspective view of the first jaw in FIG. 6 with the liners and blades in place;

FIG. 10 is a section view of the first jaw illustrating the manner by which the blades and liners are secured;

FIG. 11 is a perspective view of a second jaw of the jaw set illustrated in FIG. 3 with the liners in an exploded position;

FIG. 12 is a perspective view of the second jaw in FIG. 11 with the liners positioned within the pockets;

FIG. 13 is a perspective view of the second jaw in FIG. 11 with the liners in place and the blades shown in an exploded position;

FIG. 14 is a perspective view of the second jaw in FIG. 11 with the liners and blades in place;

FIG. 15 is a perspective view of the second jaw illustrated in FIG. 3 with the liners shown in an exploded position;

FIG. 16 is a perspective view of the second jaw in FIG. 15 with the liners positioned within the pockets;

FIG. 17 is a perspective view of the second jaw in FIG. 15 with the liners in place and the blades shown in an exploded position;

FIG. 18 is a section view of the second jaw illustrating the manner by which the blades and liners are secured; and

FIG. 19 is a perspective view of an embodiment of the second jaw showing the liners as a single piece but also with the liners generally forming an s-shaped cross section.

### DESCRIPTION OF THE INVENTION

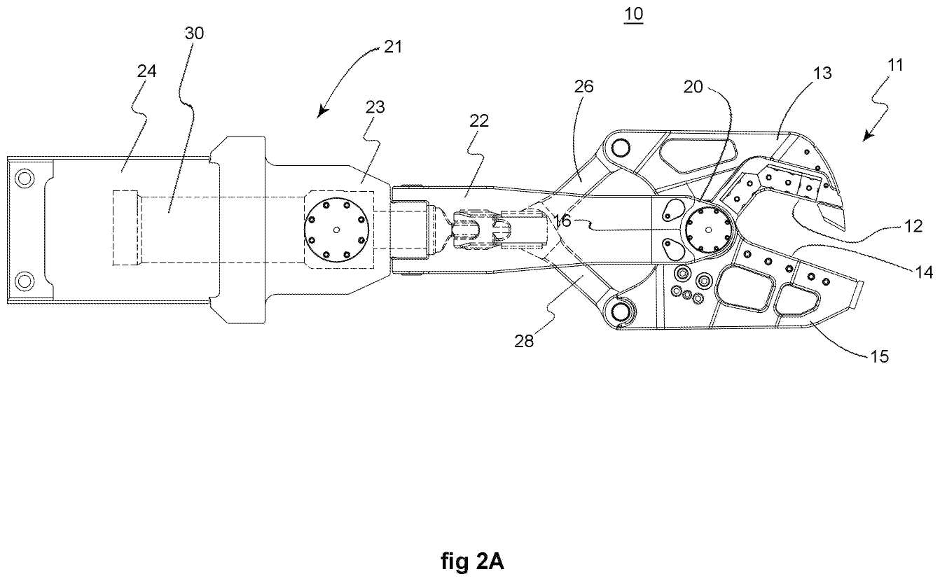

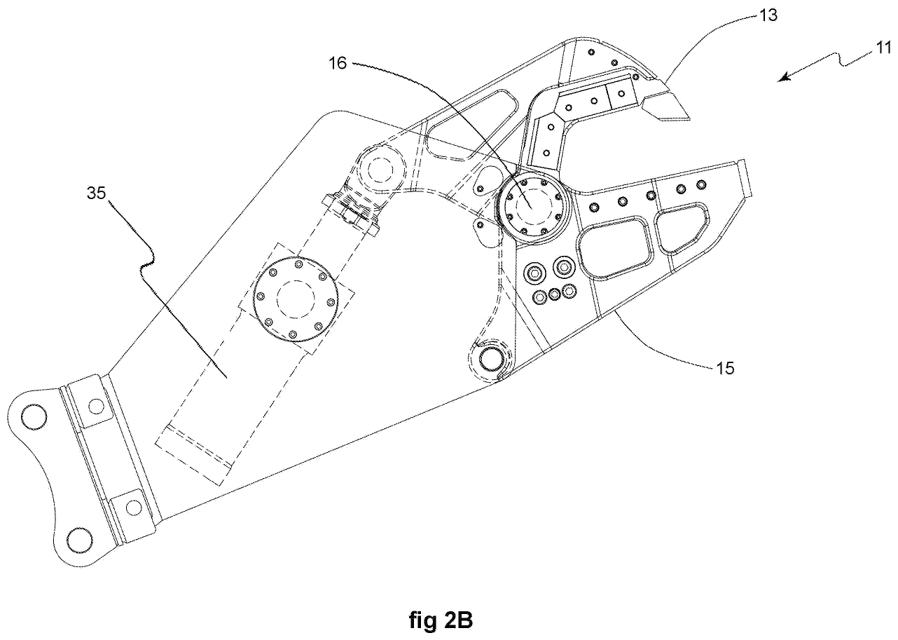

FIG. 2A illustrates a universal tool 10 with a jaw set 11 adapted to be attached to demolition or construction equipment, such as an excavator or other construction and demolition equipment (not shown). The tool 10 is adapted to connect one of a series of jaw sets 11 to the demolition equipment. As illustrated, the tool 10 is a metal shear. The shear 10 includes a first blade set 12 connected to a first jaw 13 and a second blade set 14 connected to a second jaw 15, wherein the first jaw 13 and second jaw 15 are pivotally connected at a hub or main pin 16.

A bridge housing 20 is connected to a universal body 21. The body 21 is referred to as universal because it remains common to a series of jaw sets 11 in the attachment system. The universal body 21 may be comprised of sides 22, a bearing housing 23, and a yoke 24. The first jaw 13 and the second jaw 15 may each be connected to a linkage 26, 28 and each linkage 26, 28 may be attached to at least one hydraulic cylinder 30.

As shown in FIG. 2A, the two movable jaws 13, 15 may be driven by one or more hydraulic cylinders 30 connected to the universal body 21. As shown in FIG. 2B it is possible for the first jaw 13 to rotate and the second jaw 15 to be fixed such that the hydraulic cylinder 35 drives only one jaw 13 to provide relative rotation between the jaws 13, 15. In both instances, the first jaw 13 of the jaw set 11 is adapted for relative rotation with a second jaw 15 about the pin 16. As shown in FIGS. 2A and 2B, the jaws 13, 15 have relative rotation with respect to one another about the pin 16. It is also possible for the jaws 13, 15 to rotate relative to one another about pivots that are not co-axial, but spaced from one another or for one jaw to rotate and the other jaw to be fixed, wherein the pivot pin 16 of the first jaw 13 is spaced from the fixed second jaw 15.

Generally speaking, the first jaw 13 is adapted to allow relative rotation between the first jaw 13 and the second jaw 15.

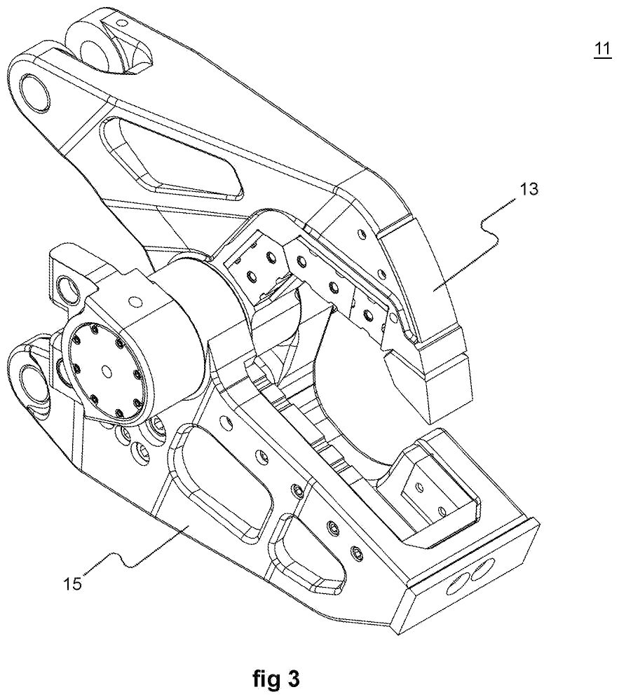

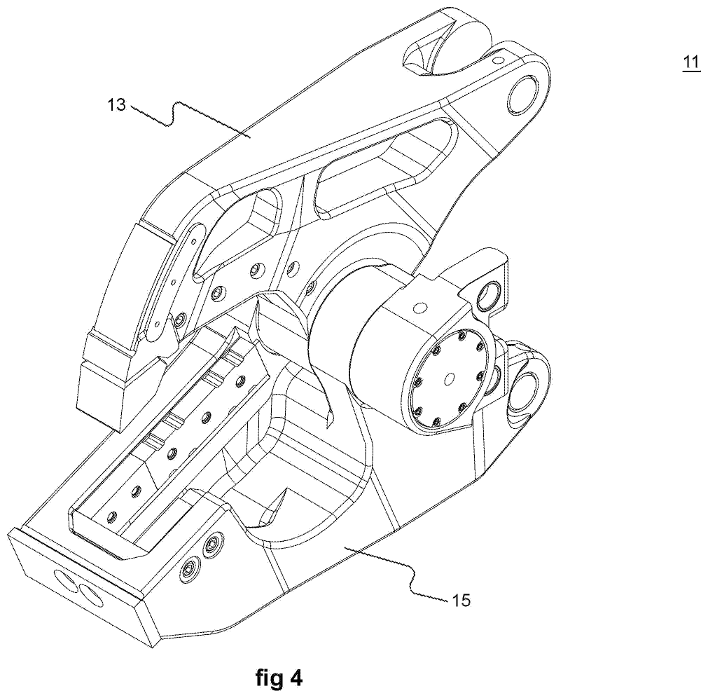

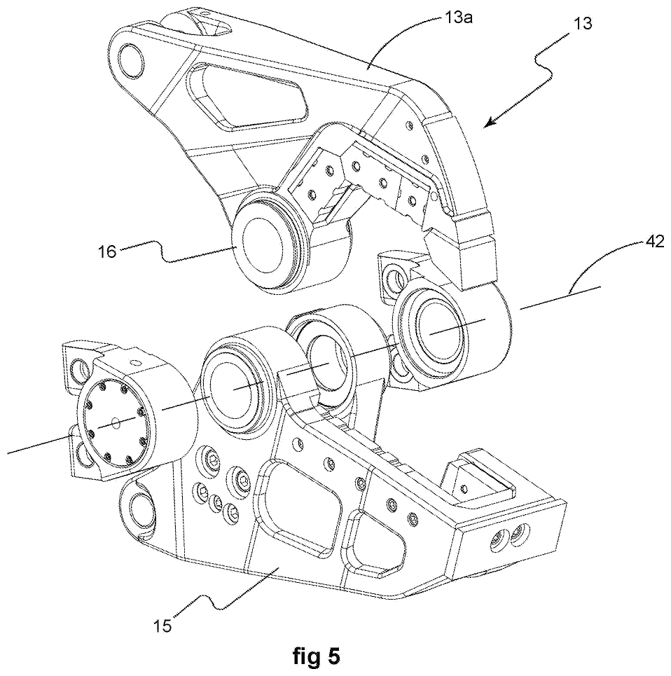

FIGS. 3-5 show the jaw set 11 with the first jaw 13 and the second jaw 15 described in FIG. 2A in different perspective views and in an exploded position with the liners and blades secured to the jaws 13, 15. These figures also present views that help to understand the invention.

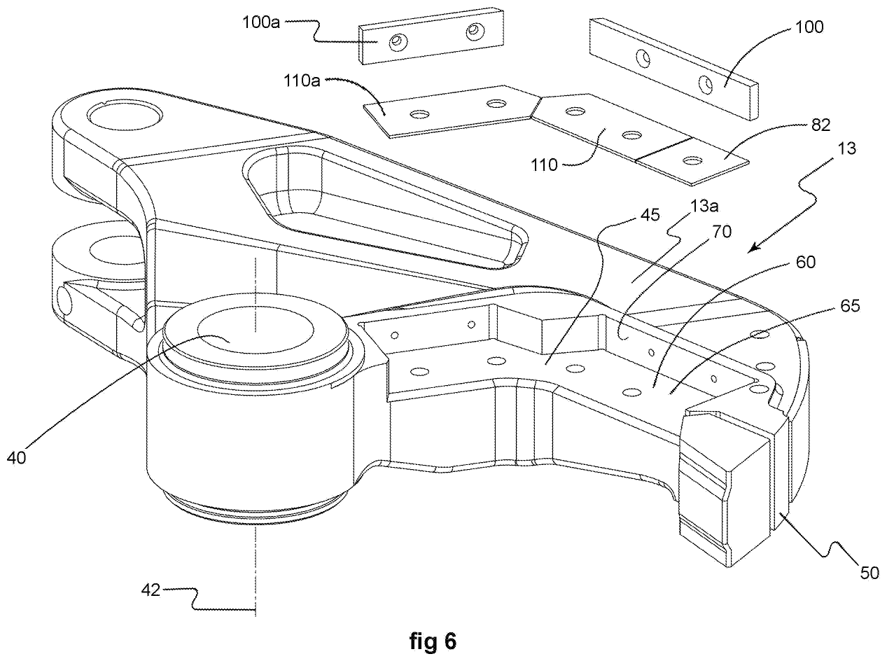

As seen in FIG. 6, the jaw 13 has a jaw body 13a with a bore 40 extending therethrough with a central axis 42. A cutting region 45 defined between the jaw body bore 40 and an end 50 of the jaw body 13a.

A first pocket 60 extends away from the jaw body 13a with a bore 40 toward the end 50 of the jaw body 13a. The first pocket 60 has a first pocket sidewall 65 oriented in a direction perpendicular to the central axis 42 of the jaw body bore 40. A first pocket end wall 70 is perpendicular to the first pocket side wall 65.

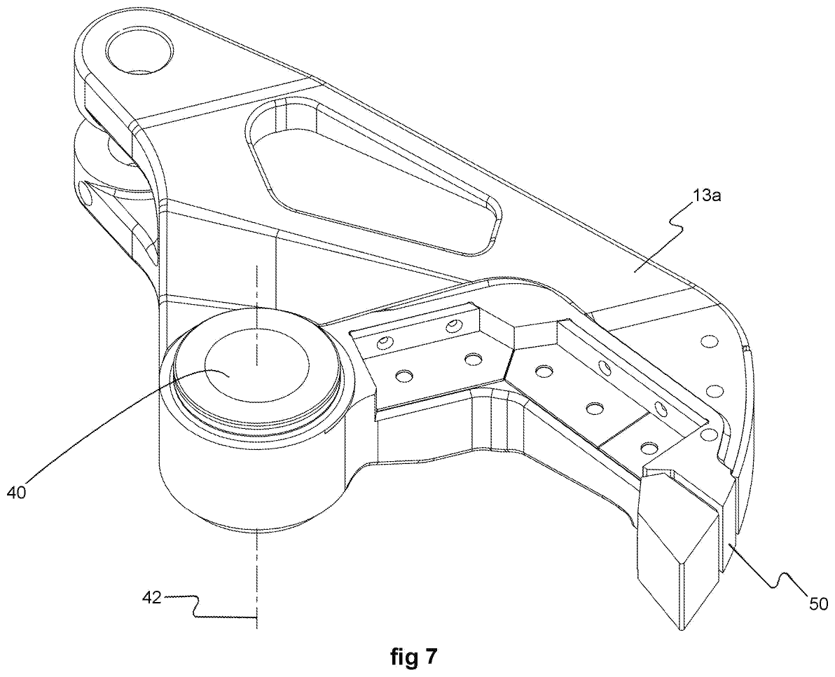

Liners are shown in exploded positions in FIG. 6 and positioned within pockets 60 in FIG. 7. While first end wall liner 100 and first side wall liner 110 are labeled and will be discussed, it should be appreciated that unless otherwise noted, the same discussion applies to the other liners illustrated in FIGS. 6 and 7.

Liners as used herein are different than shims, however as will be explained, it does not have to be an either/or arrangement. The purpose of a shim is to locate the blade at a certain position within the blade pocket. Shims are in general not intended to protect the blade pocket of the jaw body and any protection they may provide is minimal. On the other hand, a purpose of a liner is to protect the blade pocket of the jaw body from contact with the worn or deformed blade. A liner has a thickness of at least 0.125 inches thick and may be as thick as 1 inch, while a shim typically has a thickness of between 0.001 inches and 0.125 inches. The blade pockets may be damaged by blades that are worn or deformed. While a shim may provide some protection to the blade pocket, they are generally very thin and not thick enough to prevent damage to the blade pocket of the jaw body from the blade when engaging a workpiece. However, liners are thicker and provide a shield between the blade and the blade pocket. Furthermore, shims are not used for the end wall of the blade pocket and therefore cannot offer protection to that area. Liners utilized at the end wall of the blade pocket provide protection where previously none was available. It should be appreciated that shims may still be used to position a blade and may be used in conjunction with liners or separate from liners.

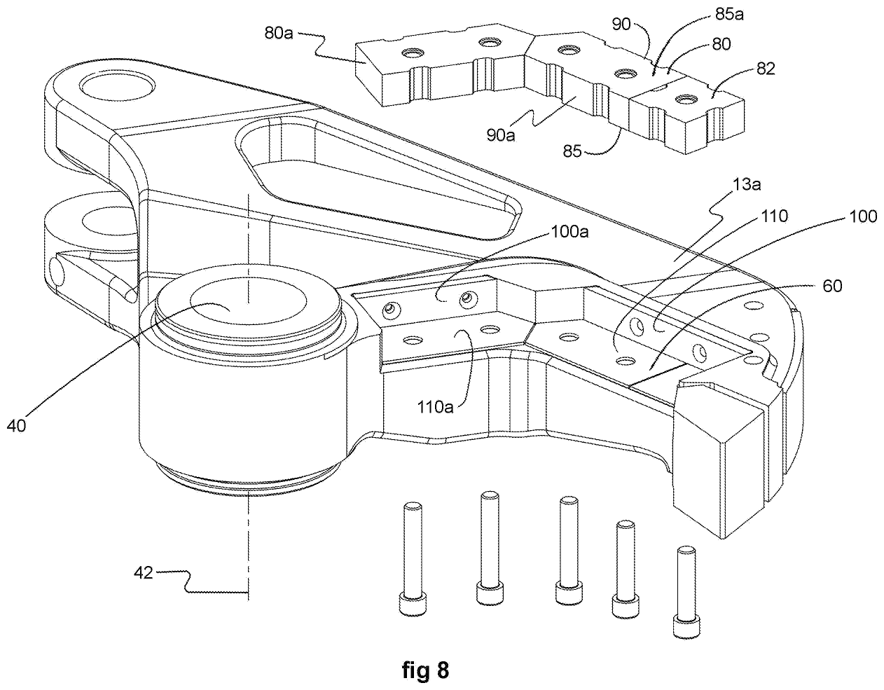

Directing attention to FIG. 8, a first blade 80 is positioned to be mounted within the first pocket 60. The first blade 80 has a first blade sidewall 85 oriented in a direction perpendicular to the central axis 42 of the jaw body 13a with a bore 40. The first blade 80 also has a first blade end wall 90 perpendicular to the first blade side wall 85. In FIG. 8, the first blade side wall 85 and the first blade end wall 90 are not visible. However, the first blade side wall 85 is identical to the surface 85a and the first blade end wall 90 is identical to the surface 90a.

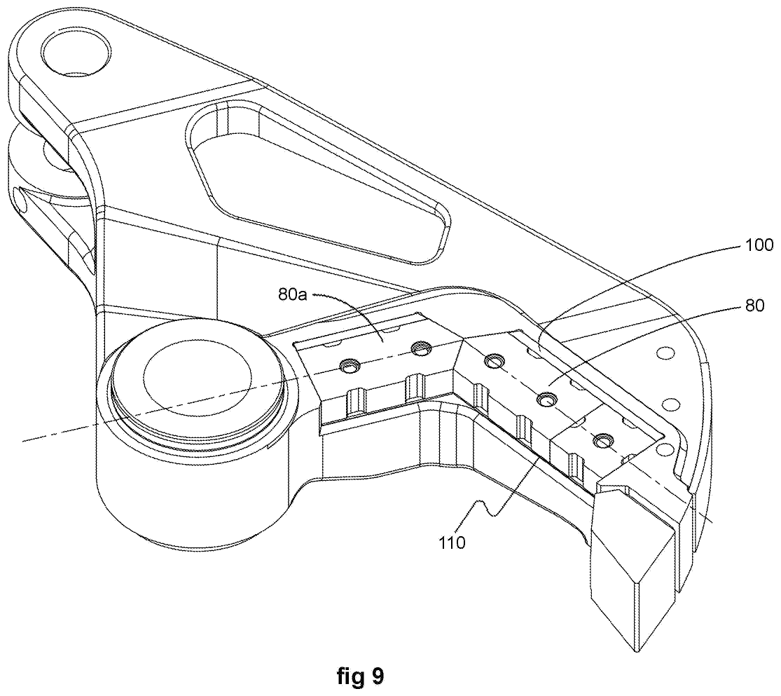

The first end wall liner 100 is positioned between the first pocket end wall 70 (FIG. 6) and the first blade end wall 90 (FIG. 8) to protect the first pocket end wall 70 and the jaw body 13a. As shown in FIG. 9, the first end wall liner 100 extends within the first pocket 60 and overlaps with the first blade 80. It should be appreciated that shims are not used against this end wall of the pocket nor against any of the end walls discussed herein.

The first side wall liner 110 is positioned between the first pocket side wall 65 (FIG. 6) and the first blade side wall 85 (FIG. 8) to protect the first pocket side wall 65 and the tool body 13a. As shown in FIG. 9, the first side wall liner 110 may extend within the first pocket 60 and overlap with the first blade 80.

As seen in FIGS. 6-8, the first end wall liner 100 and the first side wall liner 110 form an L-shape. Furthermore, the first end wall liner are 100 and the first side wall liner 110 may form a single piece.

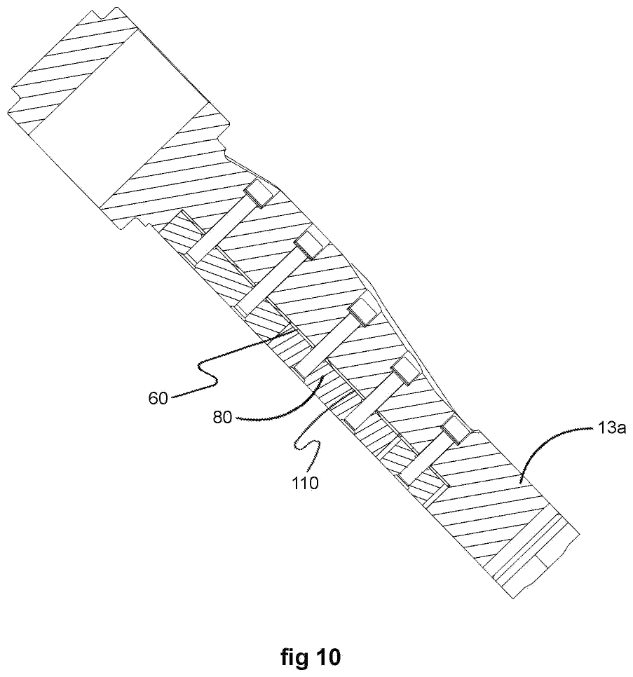

Directing attention to FIGS. 8 and 10, the first side wall liner 110 is secured to the jaw body 13a and the first blade 80 is secured to the jaw body 13a over the first side wall liner 110. Additionally, in FIG. 10, a series of bolts are illustrated as one manner of securing the blades and liners, for example blade 80 and liner 110, within the first pocket 60 of the jaw body 13a.

Directing attention to FIG. 8, within the first pocket 60 is a first blade 80. A supplemental blade 82 may be mounted within the first pocket 60. It is entirely possible for the first blade 80 to extend to the region occupied by the supplemental blade 82.

However, as illustrated in FIG. 8, the first side wall liner 110 extends essentially the entire length of the first pocket 60 such that the first end wall liner 100 is retained by both the first blade 80 and the supplemental blade 82 when they are secured within the pocket 60.

As a result, in this arrangement where the first blade 80 and the supplemental blade 82 occupy the pocket 60, each blade 80, 82 covers a portion of the first end wall liner 100 such that the first end wall liner 100 is still retained when either one of the first blade 80 or the supplemental blade 82 are removed. Although not illustrated, such an arrangement may also apply to the first side wall liner 110 if the side wall liner 110 is modified to extend the length of the first pocket 60. Once again in this situation, the first side wall liner 110 would be retained if either one of the first blade 80 or the supplemental blade 82 were removed.

Within the first pocket 60 is another blade and set of liners. The details of complimentary first blade 80a, complimentary first end wall liner 100a, and complimentary first side wall liner 110a are similar to those discussed herein with respect to first blade 80, first end wall liner 100, and first side wall liner 110.

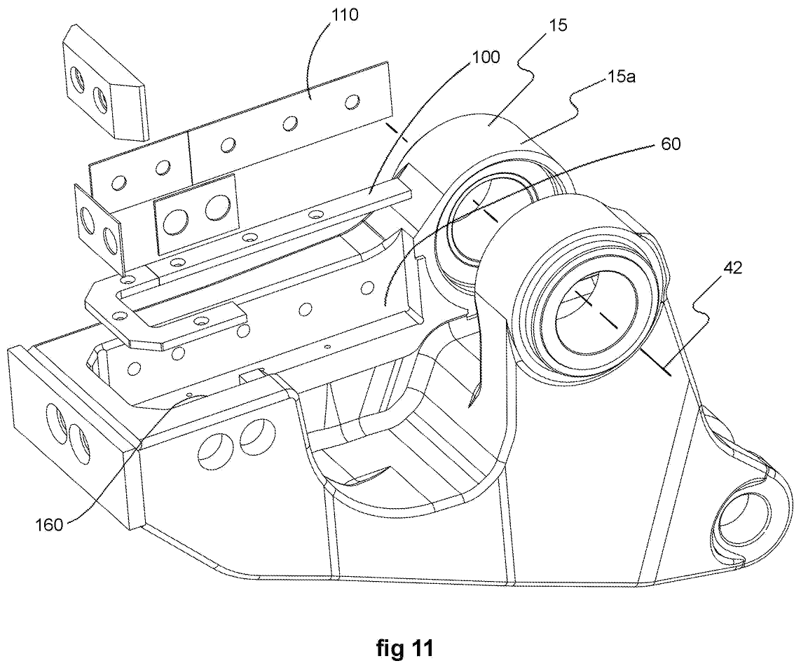

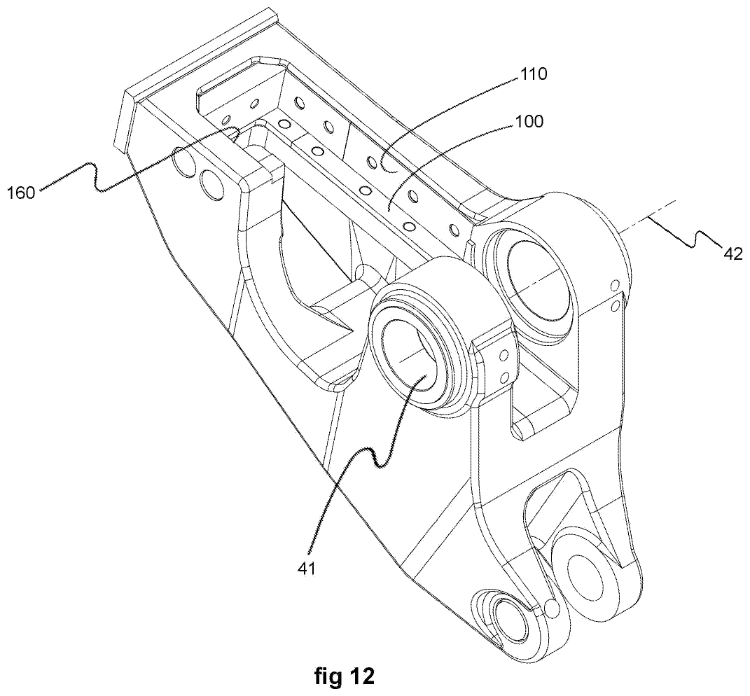

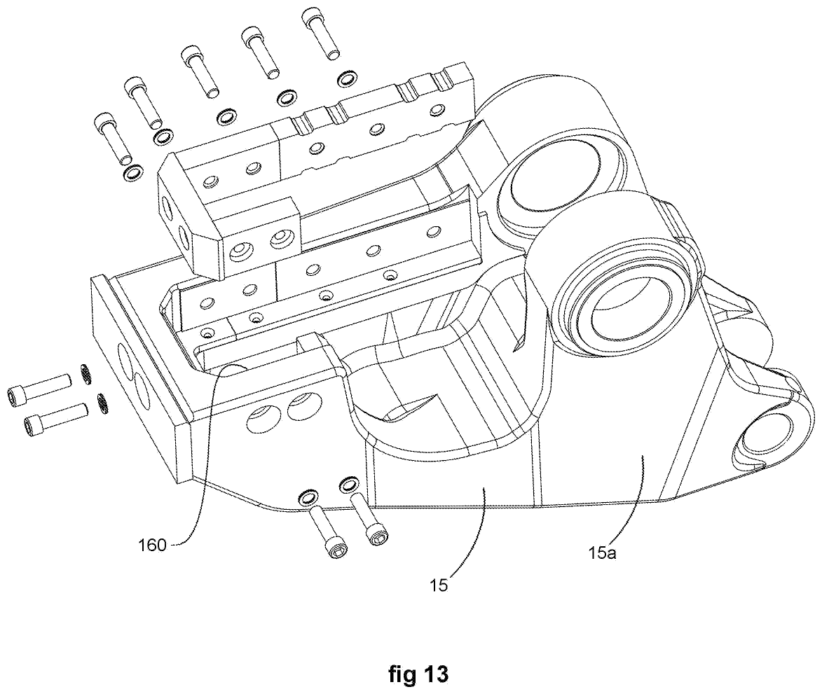

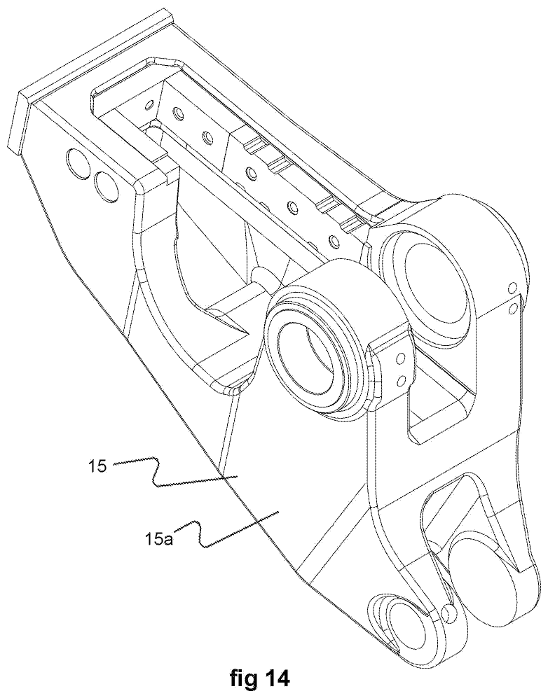

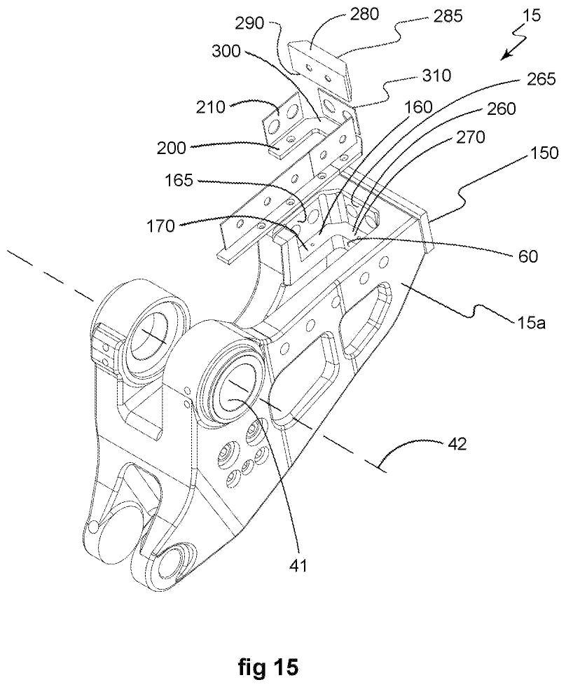

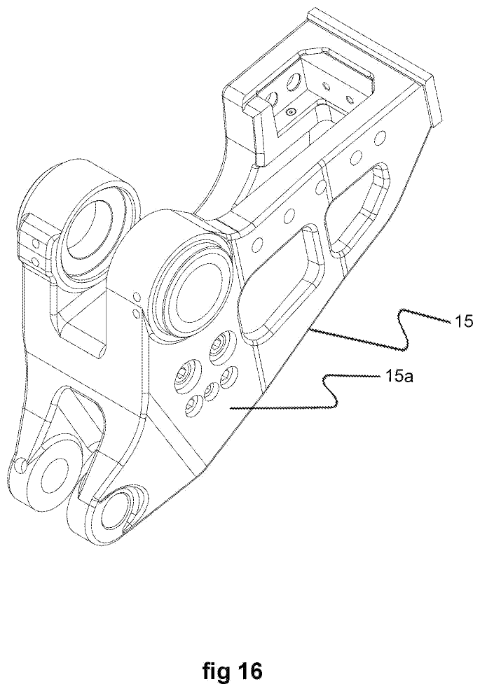

FIGS. 11-18 illustrate a second jaw 15. The features so far as described in FIGS. 3-10 associated with the first jaw 13 apply to this configuration as well and are labelled as such. FIGS. 12-14 show the second jaw 15 described in FIG. 2A with the liners in place and with the blades in an exploded position and then in an assembled position. These figures also present views that help to understand the invention. FIGS. 15-17 show this same second jaw 15, but in a different perspective view such that additional features of the invention may be viewed and discussed.

As illustrated in FIGS. 15-17, a second pocket 160 is on the opposite side of the first pocket 60 within the cutting region 45. The second pocket 160 extends between the second jaw body 15a with a bore 41 and the end 150 of the jaw body 15a. The second pocket 160 has a second pocket side wall 165 oriented in a direction perpendicular to the central axis 42 of the second jaw body 15a with a bore 41. A second pocket end wall 170 is perpendicular to the second pocket sidewall 165.

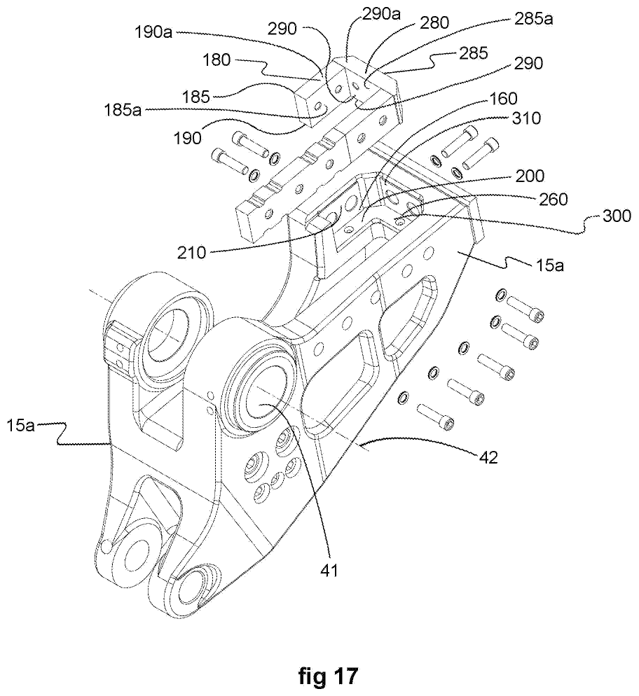

Directing attention to FIG. 17, a second blade 180 is mounted within the second pocket 160. The second blade 160 has a second blade side wall 185 oriented in a direction perpendicular to the central axis 42 of the second jaw body 15a with a bore 41. A second blade end wall 190 is perpendicular to the second blade side wall 185.

As illustrated in FIGS. 15-17, a second end wall liner 200 extends within the second pocket 160 and is positioned between the second pocket end wall 170 and the second blade end wall 190 to protect the second pocket end wall 170 and the jaw body 15a. In FIG. 17, the second blade side wall 185 and the second blade end wall 190 are not visible. However, the second blade side wall 185 is identical to the surface 185a and the second blade end wall 190 is identical to the surface 190a.

A second side wall liner 210 extends within the second pocket 160 and is positioned between the second pocket side wall 165 and the second blade side wall 185 to protect the second pocket side wall 165 and the jaw body 15a.

As illustrated in FIG. 15, the second pocket end wall liner 200 and the second pocket side wall liner 210 may form an L-shape. The second end wall liner 200 and the second side wall liner 210 may be formed of a single piece.

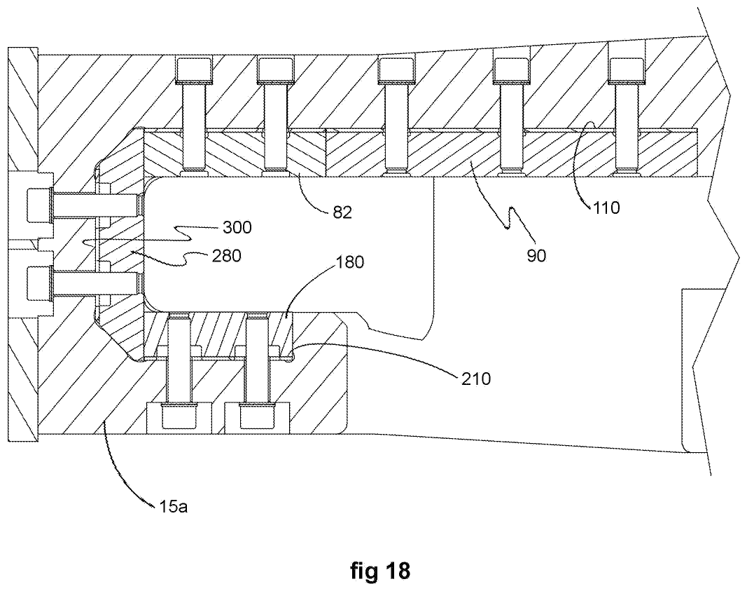

As illustrated in FIG. 18 the second side wall liner 210 is secured to the jaw body 15a and the second blade 180 is secured to the jaw body 15a over the second side wall liner 210.

Additionally, in FIG. 18, a series of bolts are illustrated as one manner of securing the blades and liners within the first pocket 60, the second pocket 160, and the third pocket 260 of the jaw body 15a.

In a fashion similar to what is previously discussed with respect to the blade 80, the second blade 180 may be made up of at least two parts (not illustrated) wherein each part covers a portion of the second end wall liner 200 such that the second end wall liner 200 is retained when only one of the blade parts is removed.

Directing attention to FIGS. 15 and 17, a third pocket 260 spans a gap between the first pocket 60 and the second pocket 160.

The third pocket 260 has a third pocket side wall 265 oriented in a direction parallel to the central axis 42 of the second jaw body 15a with a bore 41. The third pocket 260 also has a third pocket end wall 270 perpendicular to the third pocket side wall 265.

Directing attention to FIG. 17, a third blade 280 is mounted in the third pocket 260. The third blade 280 has a third blade side wall 285 oriented in a direction parallel to the central axis 42 of the second jaw body 15a with a bore 41. A third blade end wall 290 is perpendicular to the third blade side wall 285. In FIG. 17, the third blade side wall 285 and the third blade end wall 290 are not visible. However, the surface of the first blade side wall 285 is similar to the surface 285a and the first blade end wall 290 is identical to the surface 290a.

A third end wall liner 300 extends within the third pocket 260 and is positioned between the third pocket end wall 270 and the third blade end wall 290 to protect the third blade end wall 290 and the second jaw body 15a.

As illustrated in FIGS. 15 and 17, a third side wall liner 310 extends within the third pocket 260 and overlaps with the third blade 280. The third side wall liner 310 is positioned between the third pocket side wall 265 and the third blade side wall 285 to protect the third pocket side wall 265.

As illustrated in FIG. 15, the third end wall liner 300 and the third side wall liner 310 form an L shape. Additionally, the third wall end liner 300 and the third wall side liner 310 may form a single piece.

The third end wall liner 300 is secured to the second jaw body 15a and the third blade 280 is secured to the second jaw body 15a over the third end wall liner 300. As illustrated in FIG. 17, the third end wall liner 300 may have the shape of a parallelogram.

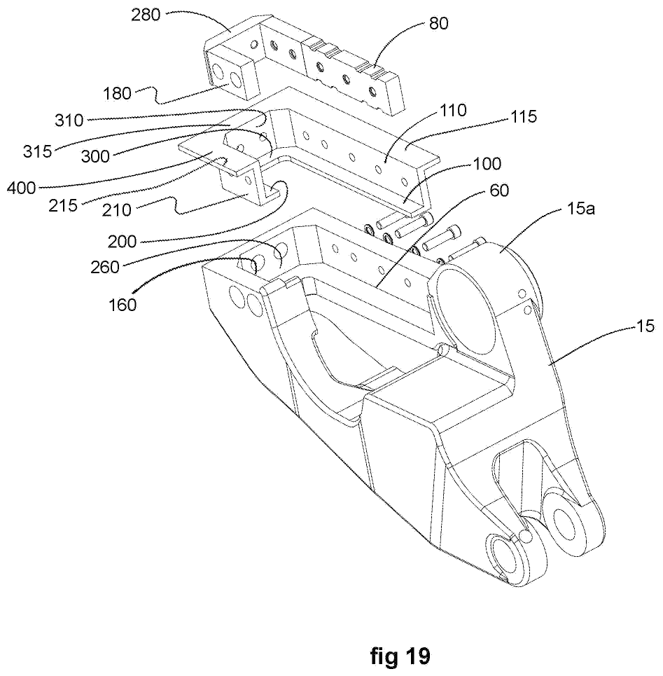

FIG. 19 illustrates different features. First of all, a total liner 400 is illustrated as a single part that encompasses the features of the first end wall liner 100, first side wall liner 110, second end wall liner 200, second end wall liner 210, third end wall liner 300 and the third side wall liner 310. It should be appreciated that while 400 is a total liner, it is possible for different portions of the liner to be combined as a total parts 400 as illustrated or by a combination of parts.

Second of all, the end wall liners 100, 200, 300 intersect with the side liners 110, 210, 310 to form a cross-section, which is an L-shape.

Third of all, FIG. 19 shows that each of the liners further includes a first outer wall liner 115, a second outer wall liner 215, and a third outer wall liner 315 that are attached to the respective side wall liners 110, 210, 310. The liners, for example, first end wall liner 100, first side wall liner 110, and first outer wall liner 115 may be formed together and have an S-shaped cross-section. It should be pointed out that shims are never used on the outer wall of a pocket.

Each of the end wall/side wall liner combinations may stand alone as a single L-shaped part or as illustrated in the other drawings may be separated.

The shape of the individual liners as discussed herein generally have a rectangular cross-section and each of the liners has a thickness of 0.125 inches or greater. The purpose of these liners is to provide sufficient material to protect the blade pockets of the jaw bodies.

The material of the liners may be softer than the blade material or the jaw body material such that the liner becomes sacrificial and may be easily replaced as opposed to the replacement of more expensive blades or repair of the tool body.

The present embodiments are merely intended to be illustrative of the present invention and not restrictive thereof. It would be apparent to those of ordinary skill in the art that various modifications may be made to the present invention without departing from the spirit and scope thereof.

The invention claimed is:

1. A first jaw configured to be part of a jaw set for demolition, recycling or material processing equipment, wherein the first jaw is comprised of a jaw body having:
1) a bore extending through the jaw body configured to be mated with a pin extending through a jaw body bore and wherein the first jaw is adapted to allow relative rotation between the first jaw and a second jaw, wherein the jaw body bore has a central axis extending therethrough and a cutting region defined between the jaw body bore and an end of the jaw body;
2) a first pocket extending away from the jaw body bore toward the end of the jaw body; wherein the first pocket has:
a) a first pocket side wall oriented in a direction perpendicular to the central axis of the jaw body bore; and
b) a first pocket end wall perpendicular to the first pocket side wall; and
3) a first blade mounted in the first pocket; wherein the first blade has
a) a first blade side wall oriented in a direction perpendicular to the central axis of the jaw body bore; and
b) a first blade end wall perpendicular to the first blade side wall; and
4) a first end wall liner extending within the first pocket overlapping with the first blade and positioned between the first pocket end wall and the first blade end wall to protect the first pocket end wall.

2. The first jaw according to claim 1, further including a first side wall liner extending within the first pocket overlapping with the first blade and positioned between the first pocket side wall and the first blade side wall to protect the first pocket side wall.

3. The first jaw according to claim 2, wherein the first end wall liner and the first side wall liner form an L-shape.

4. The first jaw according to claim 3, wherein the first end wall liner and the first side wall liner form a single piece.

5. The first jaw according to claim 4, further including a first outer wall liner adjacent to the first end wall liner and covering a portion of the jaw body, wherein the first end wall liner, the first side wall liner, and the first outer wall liner form an S-shape.

6. The first jaw according to claim 5, wherein the first end wall liner, the first side wall liner and the first outer wall liner are connected to one another to form a single part.

7. The first jaw according to claim 4, wherein the first side wall liner is secured to the jaw body and the first blade is secured to the jaw body and positioned over the first side wall liner.

8. The first jaw according to claim 1, wherein the first end wall liner extends substantially the entire length of the first pocket and further including a supplemental blade adjacent to the first blade within the first pocket, wherein each of the first blade and the supplemental blade overlap the first end wall liner such that the first end wall liner is retained within the first pocket when only one of the first blade or the supplemental blade is removed.

9. A first jaw configured to be part of a jaw set for demolition, recycling or material processing equipment, wherein the first jaw is comprised of a jaw body having:
1) a bore extending through the jaw body configured to be mated with a pin extending through the jaw body bore and wherein the first jaw is adapted to allow relative rotation between the first jaw and a second jaw, wherein the jaw body bore has a central axis extending therethrough and a cutting region defined between the jaw body bore and an end of the jaw body;
2) a first pocket extending away from the jaw body bore toward the end of the jaw body; wherein the first pocket has:
a) a first pocket side wall oriented in a direction perpendicular to the central axis of the jaw body bore; and
b) a first pocket end wall perpendicular to the side wall; and
3) a first blade mounted in the first pocket; and
4) a second pocket opposing the first pocket and extending away between the jaw body bore and the end of the jaw body, wherein the second pocket has:
a) a second pocket side wall oriented in a direction perpendicular to the central axis of the jaw body bore; and
b) a second pocket end wall perpendicular to the second pocket side wall;
5) a second blade mounted in the second pocket; wherein the second blade has
a) a second blade side wall oriented in a direction perpendicular to the central axis of the jaw body bore; and
b) a second blade end wall perpendicular to the second blade side wall; and
6) a second end wall liner extending within the second pocket and positioned between the second pocket end wall and the second blade end wall to protect the second pocket end wall.

10. The first jaw according to claim 9, further including a second side wall liner extending within the second pocket overlapping with the second blade and positioned between the second pocket side wall and the second blade side wall to protect the second pocket side wall.

11. The first jaw according to claim 10, wherein the second end wall liner and the second side wall liner form an L-shape.

12. The first jaw according to claim 11, wherein the second end wall liner and the second side wall liner form a single piece.

13. The first jaw according to claim 12, further including a second outer wall liner adjacent to the second end wall liner and covering a portion of the jaw body, wherein the second end wall liner, the second side wall liner, and the second outer wall liner form an S-shape.

14. The first jaw according to claim 13, wherein the second end wall liner, the second side wall liner and the second outer wall liner are connected to one another to form a single part.

15. The first jaw according to claim 10, wherein the second side wall liner is secured to the jaw body and the second blade is secured to the jaw body over the second side wall liner.

16. The first jaw according to claim 9, wherein the second end wall liner extends substantially the entire length of the second pocket and further including a second supplemental blade adjacent to the second blade within the second pocket, wherein each of the second blade and the second supplemental blade overlap the second end wall liner such that the second end wall liner is retained within the second pocket when only one of the second blade or the second supplemental blade is removed.

17. A first jaw configured to be part of a jaw set for demolition, recycling or material processing equipment, wherein the first jaw is comprised of a jaw body having:
1) a bore extending through the jaw body configured to be mated with a pin extending through the jaw body bore and wherein the first jaw is adapted to allow relative rotation between the first jaw and a second jaw, wherein the jaw body bore has a central axis extending therethrough and a cutting region defined between the jaw body bore and an end of the jaw body;
2) a first pocket extending away from the jaw body bore toward the end of the jaw body; wherein the first pocket has:
a) a first pocket side wall oriented in a direction perpendicular to the central axis of the jaw body bore; and
b) a first pocket end wall perpendicular to the side wall; and
3) a first blade mounted in the first pocket; and
4) a second pocket opposing the first pocket and extending away from the jaw body to define a gap between the first pocket and the second pocket, wherein the second pocket has:
a) a second pocket side wall oriented in a direction perpendicular to the central axis of the jaw body bore; and
b) a second pocket end wall perpendicular to the second pocket side wall;
5) a second blade mounted in the second pocket; and
6) a third pocket spanning a gap between the first pocket and the second pocket, wherein the third pocket has:
a) a third pocket side wall oriented in a direction parallel to the central axis of the jaw body bore; and
b) a third pocket end wall perpendicular to the third pocket side wall;
7) a third blade mounted in the third pocket; wherein the third blade has
a) a third blade side wall oriented in a direction parallel to the central axis of the jaw body bore; and
b) a third blade end wall perpendicular to the third blade side wall; and
8) a third end wall liner extending within the third pocket and positioned between the third pocket end wall and the third blade end wall to protect the third pocket end wall.

18. The first jaw according to claim 17, further including a third side wall liner extending within the third pocket overlapping with the third blade and positioned between the third pocket side wall and the third blade side wall to protect the third pocket side wall.

19. The first jaw according to claim 18, wherein the third end wall liner and the third side wall liner form an L-shape.

20. The first jaw according to claim 19, wherein the third end wall liner and the third side wall liner form a single piece.

21. The first jaw according to claim 20, further including a third outer wall liner adjacent to the third end wall liner and covering a portion of the jaw body, wherein the third end wall liner, the third side wall liner, and the third outer wall liner form an S-shape.

22. The first jaw according to claim 21, wherein the third end wall liner, the third side wall liner and the third outer wall are connected to one another to form a single part.

23. The first jaw according to claim 17, wherein the third end wall liner is secured to the jaw body and the third blade is secured to the jaw body over the third end wall liner.

24. The first jaw according to claim 17, wherein the third end wall liner is in the shape of a parallelogram.
